(19) United States
(12) Patent Application Publication
(10) Pub. No.: US 2009/0244059 A1
(43) Pub. Date: Oct. 1, 2009

(54) SYSTEM AND METHOD FOR AUTOMATICALLY GENERATING VIRTUAL WORLD ENVIRONMENTS BASED UPON EXISTING PHYSICAL ENVIRONMENTS

(76) Inventors: Gaurav N. Kulkarni, Denver, CO (US); Rick A. Hamilton, II, Charlottesville, VA (US); Anne R. Sand, Peyton, CO (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 12/055,466

(22) Filed: Mar. 26, 2008

(51) Int. Cl. G06T 15/00

(52) U.S. Cl. 345/419

(57) ABSTRACT

In general, the present invention provides a system and method for creating and utilizing virtual worlds for enhanced management of an Information Technology (IT) environment. Two dimensional (2D) and/or three dimensional (3D) virtual world renditions are automatically created to replicate the associated real-life IT environment. Such virtual environments can then be used to familiarize staff with remote locations and to securely provide virtual data center tours to others. This invention comprises a system and method of automatically creating a virtual world environment to reflect a real world environment using information stored in databases and floor plans. The virtual world environment is rendered utilizing a Virtual World Rendering Module and is updated utilizing a Virtual Instrument Update Module.

### FIELD OF THE INVENTION

Aspects of the present invention provide a system and method for utilizing virtual environments to provide an accurate view of real world facilities and resources. Using an embodiment of the present invention, the two dimensional (2D) and three dimensional (3D) virtual renditions of physical resources are automatically created to replicate real-life environments, such as computer data centers and other trackable assets.

### BACKGROUND OF THE INVENTION

Information technology (IT) systems are often housed in raised floor computer room areas within a data center environment. The servers and networking equipment are often stacked in racks and organized in rows. Many IT environments keep asset management databases recording the location and status of various assets, including servers and network devices. They may also have blueprints or floor plans showing the location of racks and equipment within a room. Tracking and documenting the location, relocation, upgrade, or replacement of equipment within a data center are typically done manually both in updating the asset databases and in updating the associated visual representations of the assets in their respective operating environments.

Physical management of servers, networking devices, and other mission-critical equipment within a data center is very challenging. As outsourcing and telecommuting become more popular, the staff, who manage these locations, increasingly work remotely, often even working from another country. Many times, such staff members have never visited or seen the data center building or raised floor IT area. Additionally, it is common practice for businesses to staff a primary production data center, where secondary back-up data centers may exist and be unstaffed. In most cases, again, supporting staff will not have seen or be familiar with the remote locations.

Often, virtual world regions, areas, and objects are created from scratch, which is very labor intensive, and may also be inaccurate when depicting a real physical environment.

When creating a virtual data center with many physical resources and location identities, it is very time-consuming to create such environments manually.

### SUMMARY OF THE INVENTION

In general, aspects of the present invention provide a way to create and/or utilize virtual worlds for enhanced management of an Information Technology (IT) environment. Two dimensional (2D) and three dimensional (3D) virtual world renditions are automatically created to replicate the associated real-life IT environment. Such virtual environments can then be used to familiarize staff with remote locations, to securely provide virtual data center tours to others, etc.

An embodiment of this invention comprises a solution for automatically creating a virtual world environment to reflect a real world environment using information stored in databases and floor plans.

Another embodiment of the present invention comprises a method for automatically creating a virtual rendition of at least one physical resource to replicate a real-life environment in a system having a gateway, a virtual rendition rendering module and at least one physical resource, the gateway acting as an interface between the at least one physical resource and the virtual rendition rendering module, the method comprising, at the gateway, receiving descriptive resource data from the at least one physical resource, at the gateway, translating the descriptive resource data so that it is utilized by the virtual rendition rendering module, and, at the rendering module, creating a virtual rendition of the at least one physical resource.

Another embodiment of the present invention comprises a computer program product embodied in a computer readable medium for operating in a system comprising a network I/O, a CPU, and one or more databases, for implementing a method for automatically creating virtual renditions of at least one physical resource to replicate a real-life environment in a system having a virtual world gateway, a virtual world rendering module and at least one physical resource, the virtual world gateway acting as an interface between the at least one physical resource and the virtual world rendering module, the method comprising, at the virtual world gateway, receiving descriptive resource data from the at least one physical resource, at the virtual world gateway, translating the data so that it is utilized by the virtual world rendering module, and, at the virtual world rendering module, creating a virtual rendition of the at least one physical resource.

In yet another embodiment, the present invention comprises a system for automatically creating virtual world graphic representations of at least one physical resource to replicate real-life environments, the system comprising a virtual world gateway connected to the at least one physical resource and a virtual world rendering module connected to the virtual world gateway, wherein the virtual world gateway receives descriptive resource data from the at least one physical resource, translates the descriptive resource data so that it is utilized by the virtual world rendering module and passes the translated descriptive resource data to the virtual world rendering module and further wherein the virtual world rendering module creates a virtual world graphic representation of the at least one physical resource.

The present invention further comprises a method for deploying a system for automatically creating a virtual rendition of at least one physical resource to replicate a real-life environment, the system comprising a virtual world gateway connected to the at least one physical resource, and a virtual world rendering module connected to the virtual world gateway, wherein the virtual world gateway being operable to receive descriptive resource data from the at least one physical resource, to translate the descriptive resource data so that it is utilized by the virtual world rendering module and to pass the translated descriptive resource data to the virtual world rendering module and further wherein the virtual world rendering module being operable to create a virtual world graphic representation of the at least one physical resource.

Still yet, any of the components of the present invention could be deployed, managed, serviced, etc., by a service provider who offers to create a virtual world environment to reflect a real world environment using information stored in databases and floor plans.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows a network which would work with an embodiment of the present invention.

FIG. 3 shows an illustrative Virtual World Gateway according to an embodiment of the present invention.

FIG. 4 shows an illustrative Resource Rendering Example according to an embodiment of the present invention.

FIG. 5 shows an illustrative Virtual World Update Subsystem according to an embodiment of the present invention.

FIG. 6 shows an illustrative Virtual World System Instrument Monitor and Management Subsystem according to an embodiment of the present invention.

FIG. 7 shows an illustrative Alternate Virtual World SIMM Embodiment according to an embodiment of the present invention.

FIG. 8 shows an illustrative Example 3D Data Center Room according to an embodiment of the present invention.

FIG. 9 shows an illustrative Example 3D Data Center Update to according an embodiment of the present invention.

FIG. 10 shows an illustrative example interactive 2D environment according to an embodiment of the present invention.

FIG. 11 shows an illustrative Data Center Floor Plan, which depicts a floor plan drawn on a grid according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Aspects of the present invention provide a solution for the automatic creation of 2D and 3D representations of a real world environment, such as a data center and each I/T device within the data center.

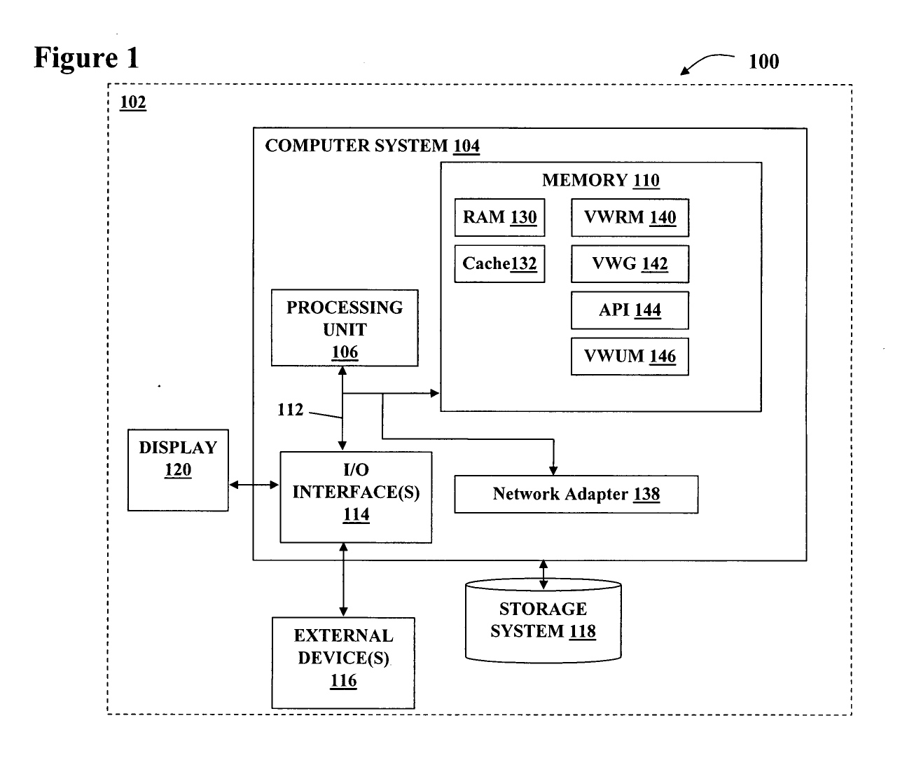

A data processing system 100, such as system 102 shown in FIG. 1, suitable for storing and/or executing program code of the present invention will include a computer system 104 having at least one processor (processing unit 106) coupled directly or indirectly to memory elements 110 through a system bus 112. The memory elements 110 can include local memory (RAM 130) employed during actual execution of the program code, bulk storage (storage 118), and cache memories (cache 132) which provide temporary storage of at least some program code in order to reduce the number of times code must be retrieved from bulk storage 118 during execution. Memory elements 110 may also a Virtual World Gateway (VWG) 142, acting as an interface between physical resources such as legacy I/T management systems and a Virtual World Rendering Module (VWRM) 140. An application programming interface (API) 144 can provide an interface an operating system to support requests for services which may be made of it from computer programs and the like. A Virtual World Update Module (VWUM) 146 may process data changes and may pass those changes to VWRM 140. Input/output or I/O devices (external devices 116) (including but not limited to keyboards, displays (Display 120), pointing devices, etc.) can be coupled to the system either directly or through intervening I/O controllers (I/O Interface(s) 114).

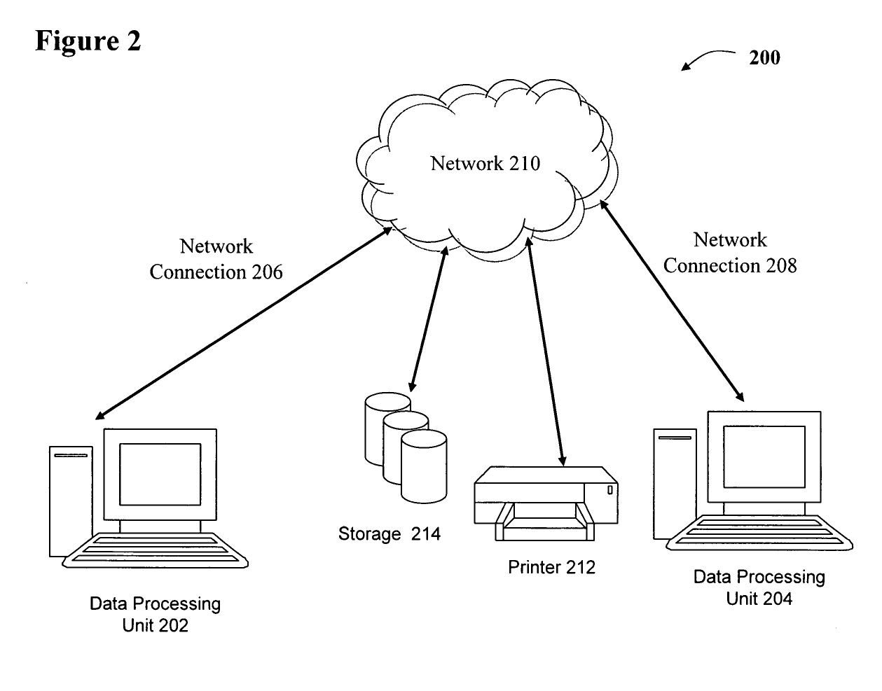

Network adapters (network adapter 138) may also be coupled to the system 200 to enable the data processing system (as shown in FIG. 2, data processing unit 202) to become coupled through network connections (Network Connection 208) to other data processing systems (data processing unit 204), remote printers (printer 212) and/or storage devices (storage 214) through intervening private and/or public networks (network 210). (A computer network is composed of multiple computers connected together using a telecommunication system for the purpose of sharing data, resources and communication. For more information, see http://historyoftheinternet.org/). Modems, cable modem and Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

Automatic Creation of 2D and 3D Representations of IT Resources

The primary logic element associated with this invention provides methods for automatic creation of 2D and 3D representations of a data center and each I/T device within the data center.

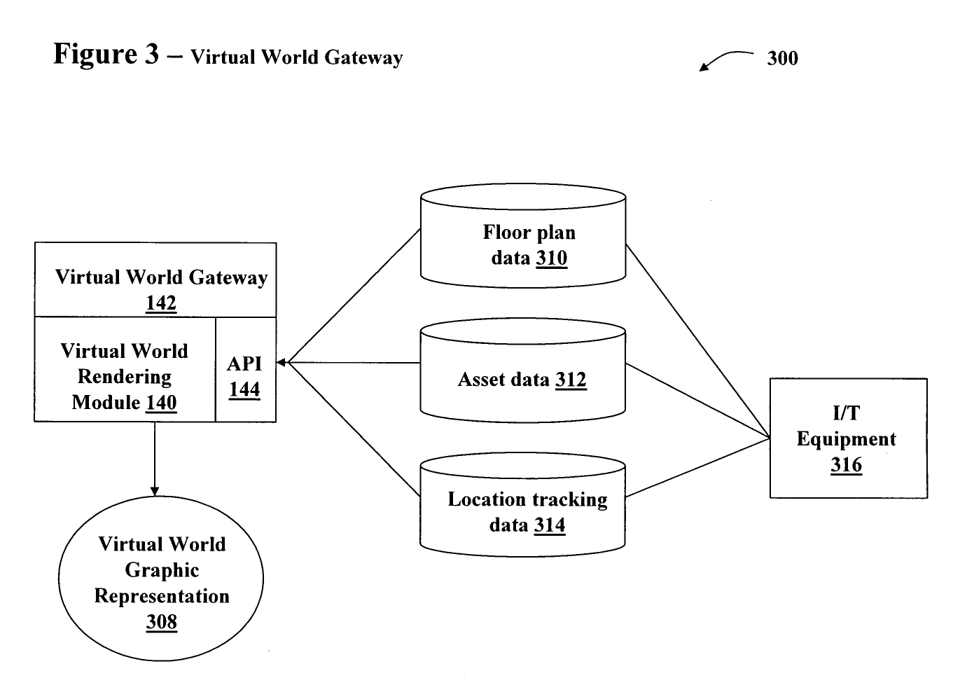

FIG. 3 depicts one possible embodiment 300 of this invention which utilizes a Virtual World Gateway (VWG) 142, acting as an interface between physical resources such as legacy I/T management systems (floor plan data 310, asset data 312, location tracking data 314 of I/T Equipment 316, for example) and the Virtual World Rendering Module (VWRM) 140. Many standards exist in the I/T industry, such that, creating an API 144 to translate standard I/T data (floor plan data 310, asset data 312, location tracking data 314) to the Virtual World Rendering Module 140 is possible. The Virtual World Gateway 142 receives descriptive resource data (floor plan data 310, asset data 312, location tracking data 314) through the API 144 from a legacy source, translates that data so that it is utilized by the VWRM 140, which in turn would create the Virtual World Graphic Representation 308 of the resource. As noted above, FIG. 3 depicts these logical relationships. For the purposes of this application, the term “translate”, “translates”, “translation”, etc., shall mean at least to be the action of interpretation of the meaning of a set of data, and subsequent production of an equivalent data, also called a translation, that communicates the same message in another language or medium. In the present case, as an example, the Virtual World Gateway 142 receives descriptive resource data—possibly in the form of coordinates—through the API 144 from a legacy source, translates that data into virtual world data, or a computer-simulated world and presents perceptual stimuli to the user representing the real world. It may be that the users, in turn, can manipulate elements of the modeled world and thus experiences telepresence to a certain degree.

The following section provides step by step example logic included in the VWG.

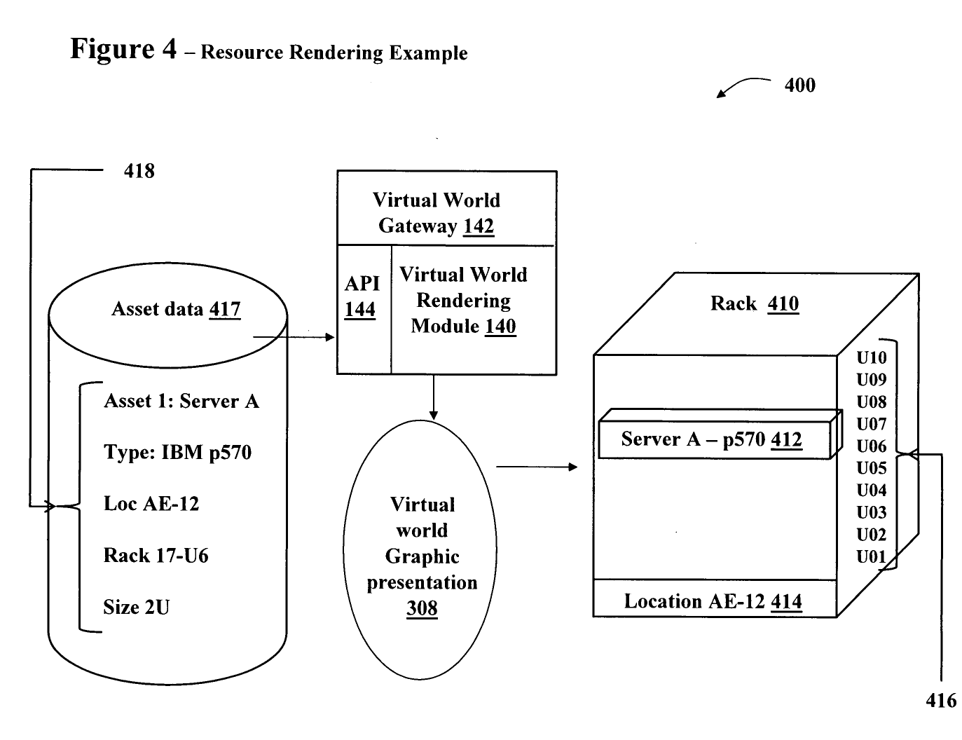

Rendering a 3D Virtual Environment from Real World Data
1) Create or access existing asset databases for equipment.
2) Create blueprint (floor plan) showing location of equipment within the room. (See Rendering a Room from Blueprints method below and FIG. 4.)
3) Create prepackaged building blocks for virtual world representation of objects based on standard definitions. Prepackaged building blocks are 2D and 3D representations of a device. For example, a 2D representation of an IBM® System p570 server may be in .gif format. A 3D representation would be an object created for use in a virtual world.
4) Sort data in asset database by unique ID—floor, row, rack, etc.
5) Build 3D environment by rack, row, floor.
   a. Import data from asset DB into VWG API 144, Simulator software, or other software entity.
   b. Build floor space based on blueprint or location data (See Rendering a Room from Blueprints method below).
   c. Build empty rack frame using rack virtual world object of appropriate dimension and type.
   d. For each individual piece of equipment:
      i. Populate rack with 3D object to represent a device
      ii. Populate 3D object with metadata from asset DB (for example: IP address, type and number of CPUs, amount of memory, etc.)
   e. Repeat steps c and d for each room or designated area until all racks and devices have logical representations capable of being rendered.

FIG. 4 depicts example logic flow 400 for rendering a physical resource based on input 418 from a legacy asset database 417. VWG 142, API 144, VWRM 140 operate and interact as discussed in relation to FIG. 3 to create VWGR 308. Input 418 comprises such data as Asset 1: Server A; Type: IBM p570; Loc AE-12; Rack 17-U6 and Size 2U. This data is used by VWG 142, API 144, VWRM 140 to create VWGR 308 which is shown as Rack 410, having Server A—p570 412, and having a location of AE-12 414.

Rendering a Room from Blueprints:

For each item, one possible implementation may include:

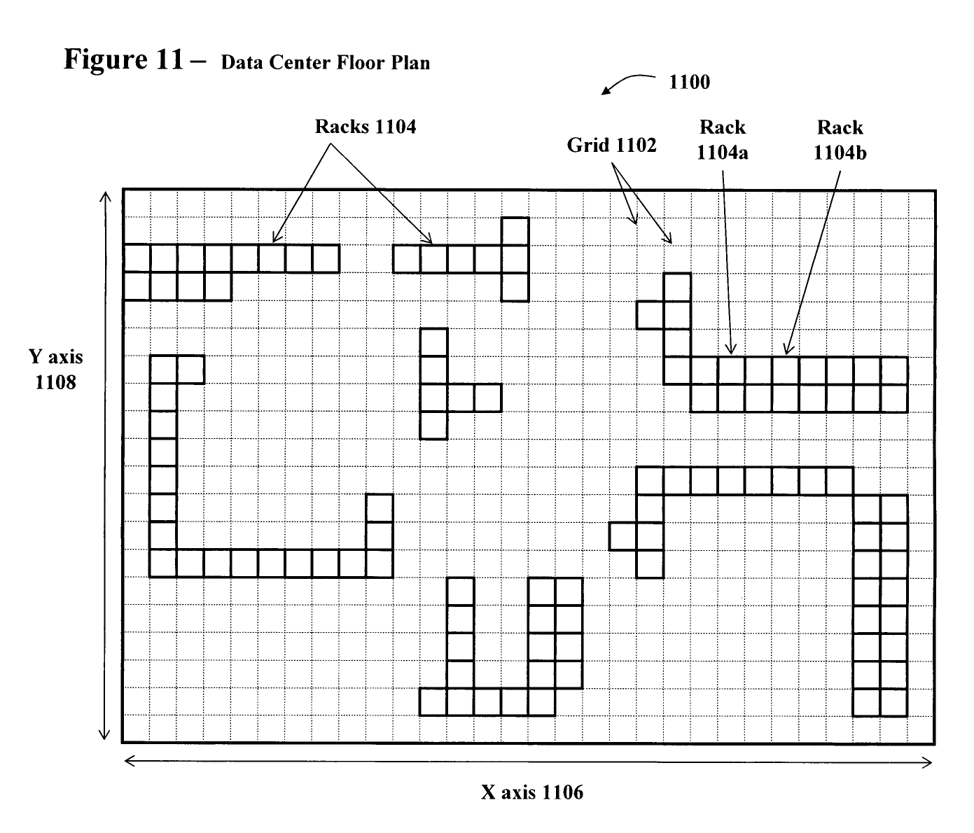

1. A 2D floor plan is built on a grid so that the system automatically knows where to place the equipment in the 3D world. (See FIG. 11—Data Center Floor Plan, which depicts a floor plan 1100 drawn on a grid 1102 illustrating racks 1104.)

2. Record coordinates of each item (such as rack 1104a, rack 1104b) from floor plan. This includes x,y placement of corners of items (along X axis 1106, Y axis 1108) or x,y coordinate of upper left corner and dimensions.

3. Optionally, convert coordinate data to table format or convert directly from blueprint.

4. Use coordinates from plan data or table to place equipment in correct location in 3D rendering of the room.

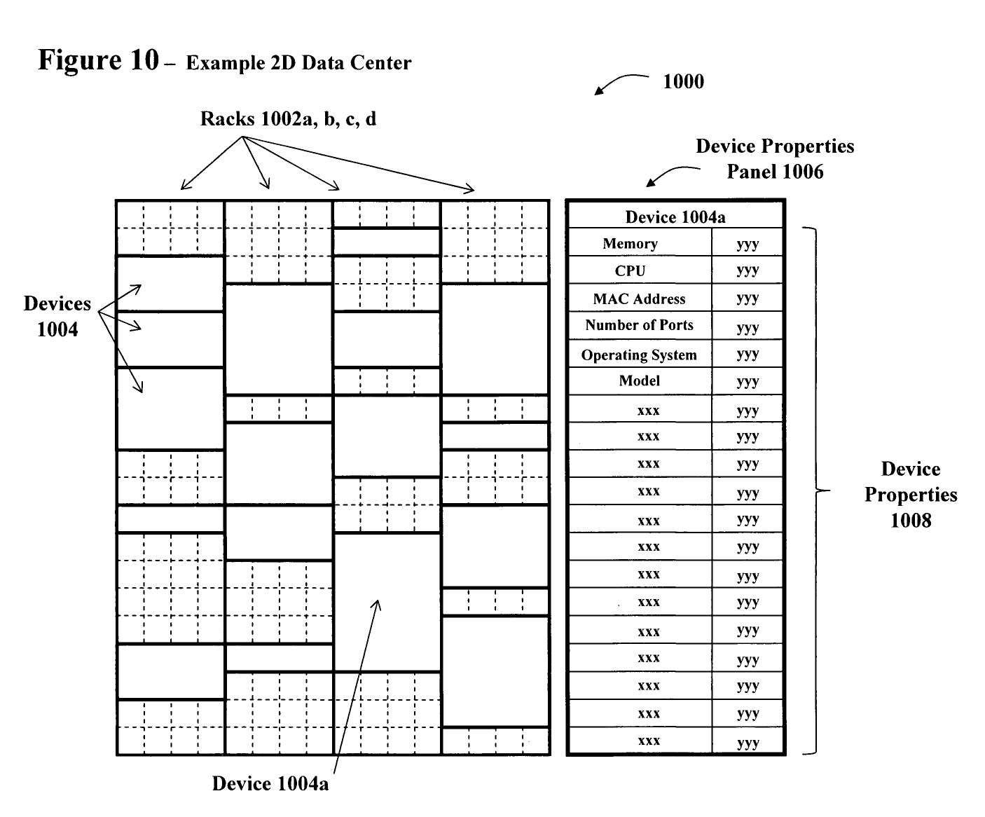

FIG. 10 depicts the resultant interactive 2D environment that is created. Devices 1004 are shown positioned in racks 1002 and, as users click or otherwise select a device 1004a located in a rack 1002c, its properties 1008 are displayed. In this example, it occurs on the panel 1006 to the right. “xxx” and “yyy” denote further properties and associated property values respectively. This 2D environment view is a helpful tool for the systems administrators, as it may be saved to a file, printed, and used to display equipment in other traditional 2D formats.

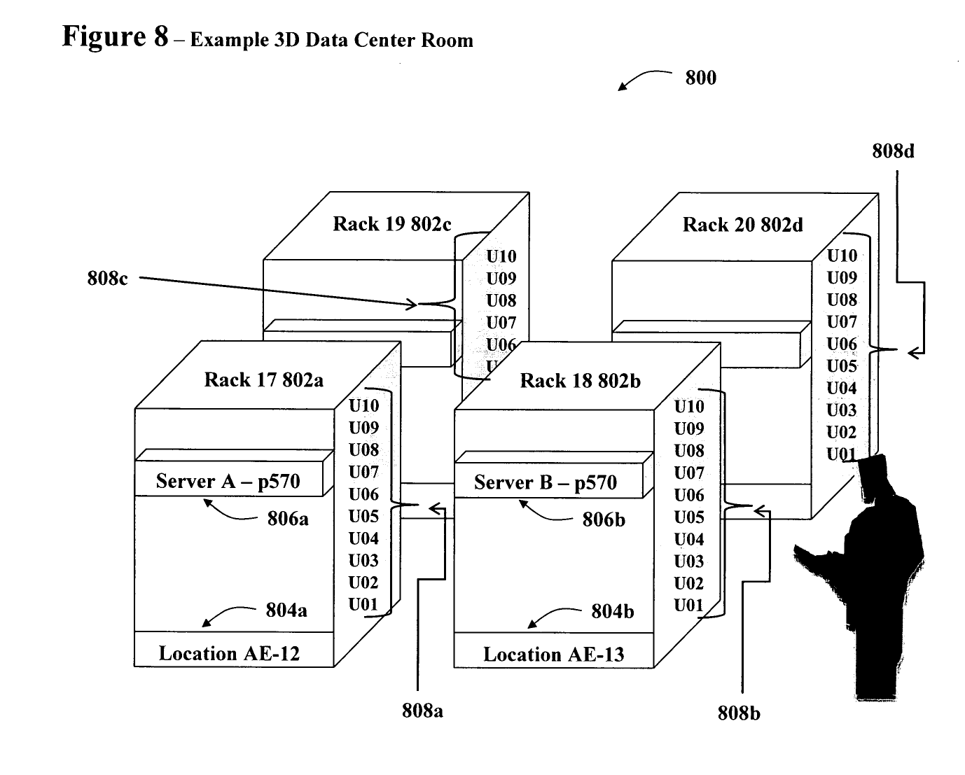

The same data used to render the 2D environment in this example may also be used to render a 3D environment in a virtual world. FIG. 8 is a simplistic example of a rendering of such a 3D representation 800 of racks 17, 18,19, 20 (802a, 802b, 802c, 802d) with racks 17, 18 (802a, 802b) holding IT devices Server A—p570 806a, Server B—p570 806b in locations Location AE-12 804a, Location AE-13 804b.

Updating Virtual Environment as Real Environment changes Occur

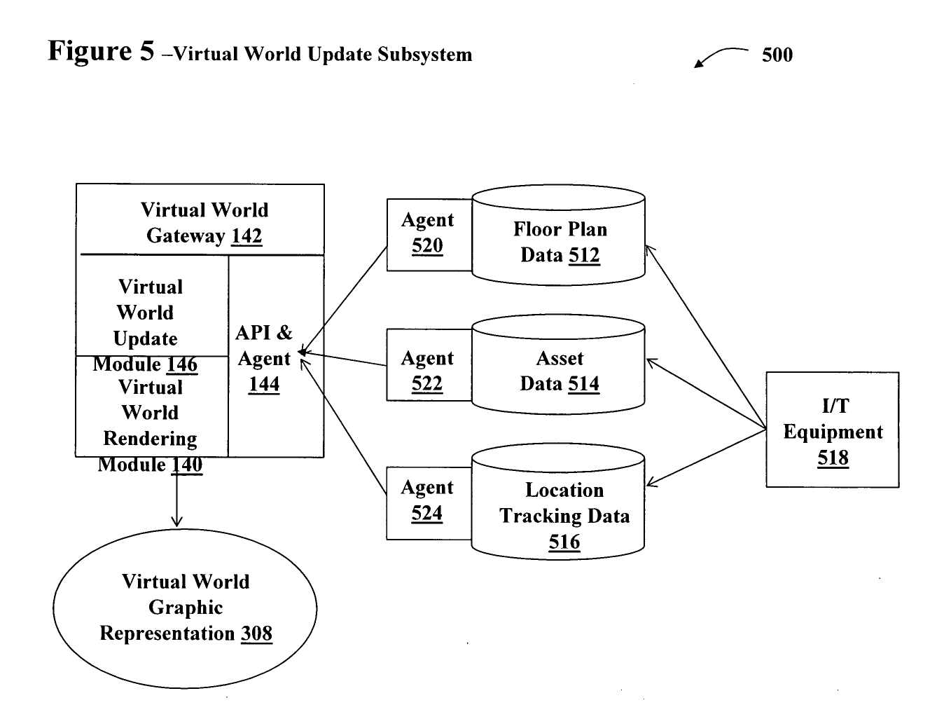

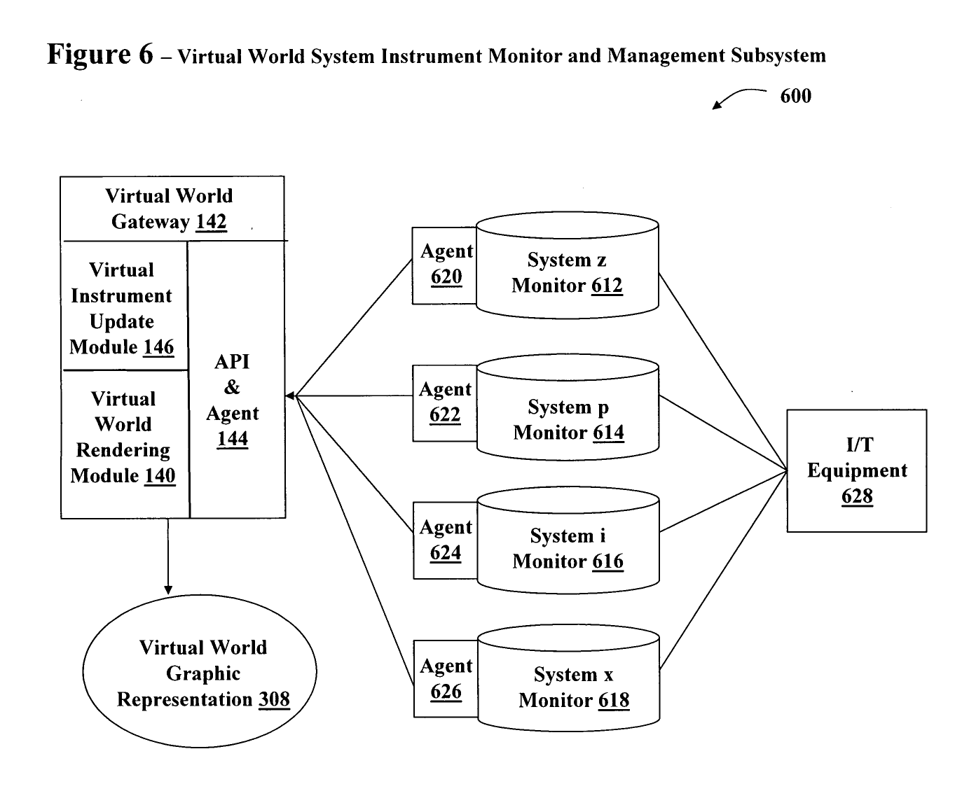

In order to update the current rendering of a virtual environment, the user need only reread the input data and re-render the environment. Alternately, only data that has been changed would be read from the input source, and thus, only the affected virtual devices would be re rendered. FIG. 5 illustrates a system for monitoring the Floor Plan Data 512, the Asset Data 514 and the Location Tracking Data 516, namely the Virtual World Update Subsytem 500 of the present invention which is similar to the Virtual World Gateway of FIG. 3 except that data 512, 514, 516 and API 504 have an agent (520, 522, 524, 504) for monitoring for changes to the real environment and passing the change data to the VWG 502 for processing. Virtual World Update Module 506 processes this change data and passes it to VWRM 508 and is processed as discussed above. FIG. 6 illustrates a system for monitoring Systems z, p, i, x of I/T Equipment 628 utilizing System z Monitor 612, System p Monitor 614, System i Monitor 616, and System x Monitor 618. Like System 500 of FIG. 5, Agents 620, 622, 624, 626 pass this data to VWG 142 for processing by Virtual Instrument Update Module 146 and Virtual World Rendering Module 140 to illustrate Virtual World Rendering Module 140.

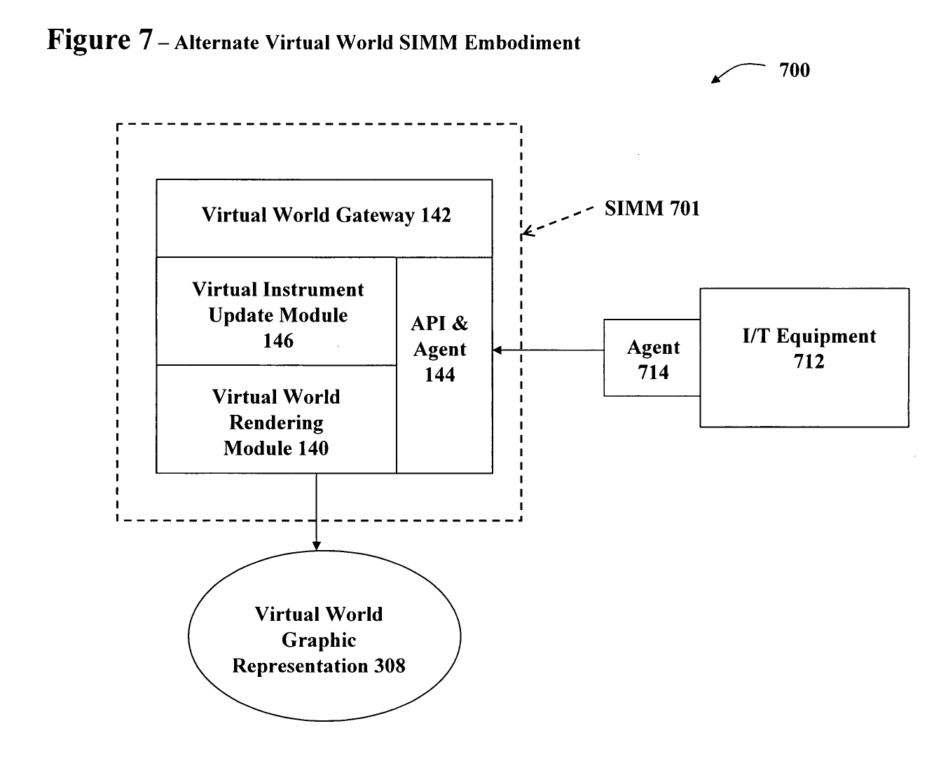

FIG. 7 illustrates an Alternate Virtual World SIMM Embodiment 700 wherein I/T Equipment 712 has its own Agent 714 for monitoring the configuration and changes to the configuration and passes this data directly to SIMM 701 having VWG 142, VIUM 146, API & Agent 144, and VWRM 140 for producing VWGR 308 per prior discussions above.

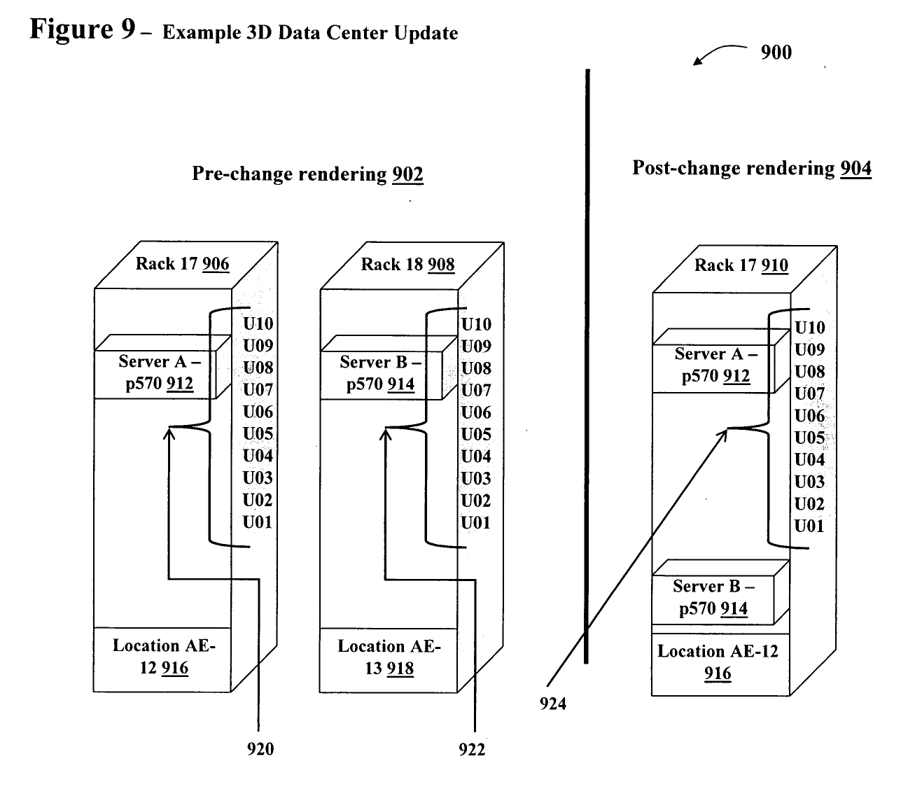

FIG. 9 illustrates an Example 3D Data Center Update 900 illustrating a Pre-change rendering 902 and a Post-change rendering 904 wherein, in the Pre-change rendering 902, Rack 17 906 having Server A—p570 912 in Location AE-12 916 and Rack 18 908 having Server B—p570 914 in Location AE-13 918. In the Post-change rendering 904, Rack 17 906 has both Server A—p570 912 and Server B—p570 914 in Location AE-12 916.

The present invention further comprises a method for deploying a system for automatically creating a virtual rendition of at least one physical resource to replicate a real-life environment, the system comprising a virtual world gateway connected to the at least one physical resource, and a virtual world rendering module connected to the virtual world gateway, wherein the virtual world gateway being operable to receive descriptive resource data from the at least one physical resource, to translate the descriptive resource data so that it is utilized by the virtual world rendering module and to pass the translated descriptive resource data to the virtual world rendering module and further wherein the virtual world rendering module being operable to create a virtual world graphic representation of the at least one physical resource. The term “replica”, “replicate”, “replication”, etc., for the purposes of this application shall mean a copy in the terms of a virtual world—that is, a virtual replica as opposed to a physical replica.

It should be understood that the present invention is typically computer-implemented via hardware and/or software. As such, and client systems and/or servers will include computerized components as known in the art. Such components typically include (among others), a processing unit, a memory, a bus, input/output (I/O) interfaces, external devices, etc. It should also be understood that although a specific embodiment involving 2D and 3D virtual renditions of physical resources which are automatically created to replicate real-life environments, such as computer data centers and other trackable assets has been depicted and described, the present invention could be implemented in conjunction with any type of real-life environments having trackable assets.

While shown and described herein as a system and method for utilizing virtual environments to provide an accurate view of real world facilities and resources, it is understood that the invention further provides various alternative embodiments. For example, in one embodiment, the invention provides a computer-readable/useable medium that includes computer program code to enable a computer infrastructure to automatically create two dimensional (2D) and three dimensional (3D) virtual renditions of physical resources to replicate real-life environments, such as computer data centers and other trackable assets. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for utilizing virtual environments to provide an accurate view of real world facilities and resources. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

In another embodiment, the invention provides a business method that performs the process steps of the invention on a subscription, advertising, and/or fee basis. That is, a service provider, such as a Solution Integrator, could offer to automatically generate virtual world environments based upon existing physical environments. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for automatically creating a virtual rendition of at least one physical resource to replicate a real-life environment in a system having a gateway, a virtual world rendering module and at least one physical resource, the gateway acting as an interface between the at least one physical resource and the virtual world rendering module, the method comprising:
at the gateway, receiving descriptive resource data from the at least one physical resource;
at the gateway, translating the descriptive resource data so that it is utilized by the virtual world rendering module; and
at the rendering module, creating a virtual rendition of the at least one physical resource.

2. The method of claim 1 wherein the descriptive resource data comprises physical resource location data, and further wherein the method further comprises the step of creating a floor plan of a room in which the at least one physical resource is located showing a location of the at least one physical resource within the room.

3. The method of claim 2 wherein the at least one physical resource has at least one device, and further wherein the method further comprises creating 2D or 3D representations of the at least one device.

4. The method of claim 3 wherein the at least one physical resource location data comprises floor, row, and rack data and further wherein the method further comprises sorting the at least one physical resource location data by unique ID and building 3D environment by rack, row, and floor.

5. The method of claim 3 wherein the system has standard definitions of objects and further wherein the method comprises creating prepackaged building blocks for virtual world representation of objects based on those standard definitions.

6. The method of claim 5 wherein the prepackaged building blocks are 2D or 3D representations of a device.

7. The method of claim 6 wherein one of the prepackaged building blocks is a rack virtual world object and the method further comprises building an empty rack frame, using the rack virtual world object of appropriate dimension and type.

8. The method of claim 7 further comprising populating the rack with prepackaged building blocks to represent devices and populating the prepackaged building blocks with metadata from the descriptive resource data.

9. The method of claim 3 wherein the floor plan is built on a grid so that the system automatically knows where to place the equipment in the 3D world and further wherein the method further comprises the step of recording coordinates of each item from floor plan including x, y placement of corners of items, or x, y coordinate of upper left corner and dimensions and the step of using coordinates from plan data or table to place equipment in correct location in 3D rendering of the room.

10. The method of claim 1 wherein the system further comprises a virtual instrument update module for receiving updated descriptive resource data when the descriptive resource data changes and wherein the method further comprises updating the virtual rendition of the at least one physical resource based upon the updated descriptive resource data.

11. A computer program product embodied in a computer readable medium for operating in a system comprising a network I/O, a CPU, and one or more databases, for implementing a method for automatically creating virtual renditions of at least one physical resource to replicate a real-life environment in a system having a virtual world gateway, a virtual world rendering module and at least one physical resource, the virtual world gateway acting as an interface between the at least one physical resource and the virtual world rendering module, the method comprising:
at the virtual world gateway, receiving descriptive resource data from the at least one physical resource;
at the virtual world gateway, translating the data so that it is utilized by the virtual world rendering module; and
at the virtual world rendering module, creating a virtual rendition of the at least one physical resource.

12. The computer program product of claim 11 wherein the descriptive resource data comprises at least one physical resource location data, and further wherein the method further comprises creating floor plan of a room in which the at least one physical resource is located showing location of the at least one physical resource within the room.

13. The computer program product of claim 12 wherein the at least one physical resource has at least one device, and further wherein the method further comprises creating 2D or 3D representations of the at least one device.

14. The computer program product of claim 13 wherein the at least one physical resource location data comprises floor, row, and rack data and wherein the method further comprises sorting the at least one physical resource location data by unique ID and building the virtual rendition by rack, row, and floor.

15. The computer program product of claim 13 wherein the system has standard definitions of objects and further wherein the method comprises creating prepackaged building blocks for virtual world representation of objects based on those standard definitions.

16. A system for automatically virtual world graphic representations of at least one physical resource to replicate real-life environments, the system comprising:
a virtual world gateway connected to the at least one physical resource; and
a virtual world rendering module connected to the virtual world gateway, wherein the virtual world gateway receives descriptive resource data from the at least one physical resource, translates the descriptive resource data so that it is utilized by the virtual world rendering module and passes the translated descriptive resource data to the virtual world rendering module and further wherein the virtual world rendering module creates a virtual world graphic representation of the at least one physical resource.

17. The system of claim 16 further comprising an application programming interface (API), connected between the virtual world gateway and the at least one physical resource, for receiving the descriptive resource data from the at least one physical resource and passing the descriptive resource data to the virtual world gateway.

18. The system of claim 17 further comprising at least one database for storing the descriptive resource data prior to sending the descriptive resource data to the virtual world gateway.

19. The system of claim 18 wherein the at least one database has an agent for monitoring the descriptive resource data and the API comprises an agent for monitoring outputs from the at least one database agent.

20. The system of claim 19 further comprising a virtual world update module for determining whether the descriptive resource data has changed since the last virtual world graphic representation was created by the virtual world rendering module and for passing the updated descriptive resource data to the virtual world rendering module.

21. The system of claim 17 wherein the at least one physical resource has at least one agent for monitoring the descriptive resource data and the API comprises an agent for monitoring outputs from the at least one physical resources agent.

22. The system of claim 21 further comprising a virtual world update module for determining whether the descriptive resource data has changed since the last virtual world graphic representation was created by the virtual world rendering module and for passing the updated descriptive resource data to the virtual world rendering module for rendering an updated virtual world graphic representation.

23. A method for deploying an application automatically creating a virtual rendition of at least one physical resource to replicate a real-life environment in a system having a gateway, a virtual world rendering module and at least one physical resource, the gateway acting as an interface between the at least one physical resource and the virtual world rendering module, the method comprising:
providing a computer infrastructure being operable to:
at the gateway, receiving descriptive resource data from the at least one physical resource;
at the gateway, translating the descriptive resource data so that it is utilized by the virtual world rendering module; and
at the rendering module, creating a virtual rendition of the at least one physical resource.

24. The method of claim 23 wherein the descriptive resource data comprises physical resource location data, and further wherein the method further comprises the step of creating a floor plan of a room in which the at least one physical resource is located showing a location of the at least one physical resource within the room.

25. The method of claim 24 wherein the at least one physical resource has at least one device, and further wherein the method further comprises creating 2D or 3D representations of the at least one device.
